(19) United States
(12) Patent Application Publication
(10) Pub. No.: US 2018/0045869 A1
(43) Pub. Date: Feb. 15, 2018

(54) OPTICAL OBSERVATION DEVICE AND METHOD OF CONTROLLING OPTICAL OBSERVATION DEVICE

(71) Applicant: FUJIFILM Corporation, Tokyo (JP)

(72) Inventors: Tomoyuki KAWAI, Saitama-shi (JP); Chikara YAMAMOTO, Saitama-shi (JP)

(73) Assignee: FUJIFILM Corporation, Tokyo (JP)

(21) Appl. No.: 15/783,359

(22) Filed: Oct. 13, 2017

Related U.S. Application Data
(63) Continuation of application No. PCT/JP2016/057218, filed on Mar. 8, 2016.

(30) Foreign Application Priority Data
Apr. 15, 2015 (JP) 2015-083157

(51) Int. Cl. G02B 5/30; G02B 27/28; G02B 23/02

(52) U.S. Cl. CPC G02B 5/30; G02B 23/02; G02B 27/286; G02B 27/285; G02B 27/288

(57) ABSTRACT

The first polarizing element transmits a specific linear polarized component. The first polarizing element is rotatably disposed on a surface orthogonal to an optical axis of a first optical path, and is rotated and driven by the first rotation drive unit. The linear polarized component extraction unit is disposed on a second optical path which is parallel to and independent of the first optical path, and extracts linear polarized components from an incidence ray, respectively, with respect to a plurality of polarization directions. The polarization direction detection unit detects an optimum polarization direction on the basis of imaging signals. The rotation control unit controls the first rotation drive unit, to set the first polarizing element at an angle that allows transmission of a linear polarized component in the optimum polarization direction.

### CROSS-REFERENCE TO RELATED APPLICATIONS

This application is a Continuation of PCT International Application No. PCT/JP2016/057218 filed on Mar. 8, 2016, which claims priority under 35 U.S.C §119(a) to Japanese Patent Application No. 2015-083157 filed on Apr. 15, 2015. The above application is hereby expressly incorporated by reference, in its entirety, into the present application.

### BACKGROUND OF THE INVENTION

### 1. Field of the Invention

The present invention relates to an optical observation device including a polarizing element and a method of controlling an optical observation device.

### 2. Description of the Related Art

When a scene including the surface of the water, window glass or the like is observed in an optical observation device such as binoculars, a situation may occur in which reflected light from the surface of the water, window glass or the like is strong, and an original observation object is not likely to be visually recognized. Consequently, an optical observation device such as binoculars having a polarizing element incorporated into an optical system is known in order to cut unnecessary light such as reflected light (see JP2010-2574A). This polarizing element guides an observation image in which the unnecessary light is cut to an ocular portion by transmitting only a linear polarized component in a direction along a polarization axis from the optical image.

However, optimum orientations of the polarizing element for cutting the unnecessary light are different from each other depending on an observation object. Therefore, in order to obtain a satisfactory observation image, it is necessary to rotate the polarizing element and to be directed toward an optimum direction in which the visibility of the observation image is most improved. Binoculars disclosed in JP2010-2574A include a half mirror and a sensor portion in order to automatically set the orientation of the polarizing element in an optimum direction. The half mirror guides a linear polarized component transmitted through the polarizing element to the ocular portion and the sensor portion.

In the binoculars disclosed in JP2010-2574A, an optimum direction is detected on the basis of an imaging signal obtained in the sensor portion while the polarizing element is rotated, and the angle of the polarizing element is set in the detected optimum direction. Thereby, the orientation of the polarizing element is automatically set in the optimum direction.

However, the binoculars disclosed in JP2010-2574A are configured such that light transmitted through the polarizing element is branched by the half mirror and is guided to the ocular portion and the sensor portion. Therefore, even in a situation in which a user observes an observation image from the ocular portion, the polarizing element is rotated in order to detect an optimum direction, and thus there is a problem in that the brightness of the observation image changes with the rotation of the polarizing element.

### SUMMARY OF THE INVENTION

An object of the present invention is to provide an optical observation device that makes it possible to set a polarizing element at an optimum angle without changing the brightness of an observation image, and a method of controlling an optical observation device.

According to the present invention, there is provided an optical observation device comprising an objective lens, an observation unit, a first polarizing element, a first rotation drive unit, a linear polarized component extraction unit, an imaging element, a polarization direction detection unit, and a rotation control unit. The objective lens allows light to be incident thereon from an observation object. An observation unit has an incidence ray incident on the objective lens guided thereto through a first optical path. A first polarizing element is a polarizing element that transmits a specific linear polarized component, and is rotatably disposed on a surface orthogonal to an optical axis of the first optical path. A first rotation drive unit rotates and drives the first polarizing element. A linear polarized component extraction unit is disposed on a second optical path having the same angle of view as that of the first optical path or having a larger angle of view than that of the first optical path, and extracts linear polarized components from the incidence ray, respectively, with respect to a plurality of polarization directions. An imaging element individually captures images of the respective linear polarized components extracted by the linear polarized component extraction unit and outputs imaging signals. A polarization direction detection unit detects an optimum polarization direction based on an image of the observation object, on the basis of the imaging signals. A rotation control unit controls the first rotation drive unit, to set the first polarizing element at an angle that allows transmission of a linear polarized component in the optimum polarization direction.

It is preferable that the polarization direction detection unit detects a polarization direction in which luminance of the image of the observation object becomes lowest.

It is preferable that the linear polarized component extraction unit includes a second polarizing element which is a polarizing element that transmits the specific linear polarized component, and is disposed on a surface orthogonal to an optical axis of the second optical path, and a second rotation drive unit that rotates and drives the second polarizing element, and sequentially extracts linear polarized components, respectively, with respect to the plurality of polarization directions by causing the imaging element to perform multiple times of imaging operations within a constant angular range in which the second polarizing element is rotated.

It is preferable that the angular range is 180°.

It is preferable that the linear polarized component extraction unit is a third polarizing element, having a plurality of polarization regions divided and fixedly disposed on the second optical path, which simultaneously extracts linear polarized components with respect to the plurality of polarization directions, polarization directions of linear polarized components transmitted by the respective polarization regions being different from each other.

It is preferable that the third polarizing element is provided on an imaging surface of the imaging element.

It is preferable that the imaging element is a color sensor having multi-color pixels, and is configured such that at least one or more pixels of each color are disposed in one polarization region.

It is preferable to further comprise: a dimming element, having a plurality of segments of which light transmittance is variable, which is disposed on the first optical path; and a dimming element control unit that controls light transmittances of the respective segments on the basis of the imaging signals in which the optimum polarization direction is detected.

It is preferable to further comprise an ocular lens provided on the first optical path between the first polarizing element and the observation unit, wherein the dimming element is disposed between the ocular lens and the observation unit.

It is preferable that a half mirror is disposed on the first optical path, and that the second optical path is branched from the first optical path by the half mirror.

It is preferable to further comprise: a rotation stop operating unit that makes it possible for a user to stop a rotation of the first polarizing element which is rotated during execution of a calibration operation for calibrating a set position of the first polarizing element by the rotation control unit; and a calibration control unit that drives the first rotation drive unit to rotate the first polarizing element, and calibrates the set position on the basis of a difference between a rotation stop position of the first polarizing element stopped by the rotation stop operating unit being operated at a position where an amount of light of an optical image of the observation object guided to the observation unit becomes smallest and the optimum polarization direction detected by the polarization direction detection unit.

It is preferable to further comprise a display unit that displays an image based on the imaging signals in which the optimum polarization direction is detected.

It is preferable that the image displayed on the display unit is guided to the observation unit through the first optical path.

It is preferable to further comprise a calibration operation start operating unit for starting the calibration operation, wherein the calibration control unit rotates the first polarizing element while the calibration operation start operating unit is operated, and the rotation stop operating unit is operated.

According to the present invention, there is provided a method of controlling an optical observation device, the device including an objective lens on which light is incident from an observation object, an observation unit to which an incidence ray incident on the objective lens is guided through a first optical path, a first polarizing element which is a polarizing element that transmits a specific linear polarized component, and is rotatably disposed on a surface orthogonal to an optical axis of the first optical path, a first rotation drive unit that rotates and drives the first polarizing element, a linear polarized component extraction unit, disposed on a second optical path having the same angle of view as that of the first optical path or having a larger angle of view than that of the first optical path, which extracts linear polarized components from the incidence ray, respectively, with respect to a plurality of polarization directions, an imaging element that individually captures images of the respective linear polarized components extracted by the linear polarized component extraction unit and outputs imaging signals, and a polarization direction detection unit that detects an optimum polarization direction based on an image of the observation object, on the basis of the imaging signals, the method comprising controlling the first rotation drive unit, to set the first polarizing element at an angle that allows transmission of a linear polarized component in the optimum polarization direction.

According to the present invention, the optimum polarization direction is detected on the basis of the imaging signal obtained by individually capturing images of a plurality of linear polarized components extracted by the linear polarized component extraction unit disposed on the second optical path, and the first polarizing element disposed on the first optical path is set at an angle that allows the transmission of a linear polarized component in the optimum polarization direction. Therefore, it is possible to provide an optical observation device that makes it possible to set a polarizing element at an optimum angle without changing the brightness of an observation image, and a method of controlling an optical observation device.

### BRIEF DESCRIPTION OF THE DRAWINGS

FIG. 1 is a perspective view of the outward appearance of binoculars.

FIG. 2 is a block diagram illustrating a configuration of the binoculars.

FIG. 3 is a diagram illustrating rotation control of a first polarizing element.

FIG. 4 is a diagram illustrating rotation control of a second polarizing element.

FIG. 5 is a diagram illustrating a relationship between the rotation angle and the imaging timing of the second polarizing element.

FIG. 6 is a diagram illustrating a region of detection of luminance.

FIG. 7 is a flow diagram illustrating an operation of an automatic mode.

FIG. 8 is a diagram illustrating detection of an optimum polarization direction based on the frequency distribution of pixel values.

FIG. 9 is a block diagram illustrating a polarization control unit of a second embodiment.

FIG. 10 is a diagram illustrating a third polarizing element.

FIG. 11 is a block diagram illustrating a configuration of binoculars of a third embodiment.

FIG. 12 is a diagram illustrating a color filter.

FIG. 13 is a diagram illustrating a relationship between first to sixth polarization regions and the color filter.

FIG. 14 is a block diagram illustrating a configuration of binoculars of a fourth embodiment.

FIG. 15 is a diagram illustrating segments of a dimming element.

FIG. 16 is a block diagram illustrating a configuration of binoculars of a fifth embodiment.

FIG. 17 is a diagram illustrating a configuration in which a second optical path is branched using an erecting prism.

FIG. 18 is a block diagram illustrating a configuration of binoculars of a sixth embodiment.

### DESCRIPTION OF THE PREFERRED EMBODIMENTS

### First Embodiment

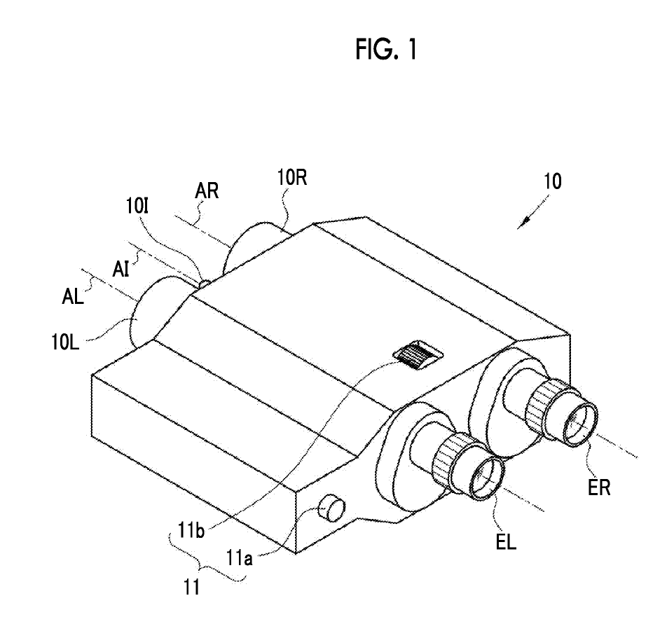

In FIG. 1, binoculars 10 include a first optical system 10R, a second optical system 10L, and an imaging optical system 101. The first optical system 10R erects an optical image of an observation object which is incident along an optical axis AR, and guides the optical image to a first ocular portion ER with which an observer's right eye comes into contact. The second optical system 10L erects an optical image of the observation object which is incident along an optical axis AL from the observation object, and guides the optical image to a second ocular portion EL with which the observer's left eye comes into contact. The first ocular portion ER and the second ocular portion EL corresponds to an “observation unit” in the claims.

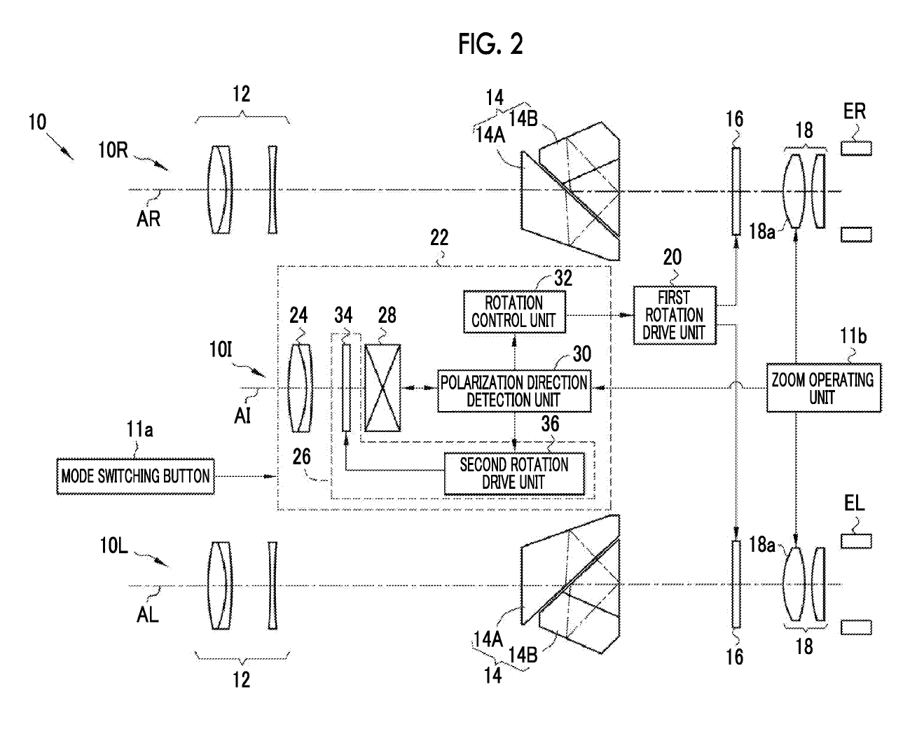

The imaging optical system 101 guides an optical image of the observation object which is incident along an optical axis AI to an imaging element 28 (see FIG. 2) provided inside the binoculars 10. The optical axis AR, the optical axis AL, and the optical axis AI are parallel to each other. The optical axis AR and the optical axis AL correspond to a “first optical path” in the claims. The optical axis AI corresponds to a “second optical path” in the claims.

The binoculars 10 are provided with an operating unit 11. The operating unit 11 includes a mode switching button 11a and a zoom operating unit 11b. The mode switching button 11 a is operated when an observation mode is switched. The observation mode includes a fixed mode and an automatic mode. In the fixed mode, the polarization axis of a first polarizing element 16 (see FIG. 2) described later is fixed in a constant direction. In the automatic mode, the polarization axis of the first polarizing element 16 is automatically controlled so as to be directed toward an optimum polarization direction at all times. The zoom operating unit 11 b is operated when zoom magnification is changed.

In FIG. 2, the first optical system 10R includes an objective lens 12, an erecting prism 14, a first polarizing element 16, and an ocular lens 18. The objective lens 12, the erecting prism 14, the first polarizing element 16, and the ocular lens 18 are disposed on the optical axis AR of the first optical system I OR in this order from the observation object side.

Light is incident on the objective lens 12 from the observation object. The objective lens 12 is constituted by a plurality of optical lenses. The objective lens 12 is configured such that the optical images can be focused by moving all or some of the plurality of optical lenses using a mechanism which is not shown.

The erecting prism 14 is a Schmidt-Pechan type prism, and erects and emits an optical image of the observation object incident from the objective lens 12. The erecting prism 14 is constituted by an auxiliary prism 14A and a roof prism 14B. The optical image is incident on the auxiliary prism 14A from the objective lens 12. The optical image is incident on the roof prism 14B from the auxiliary prism 14A. The roof prism 14B emits the erected optical image.

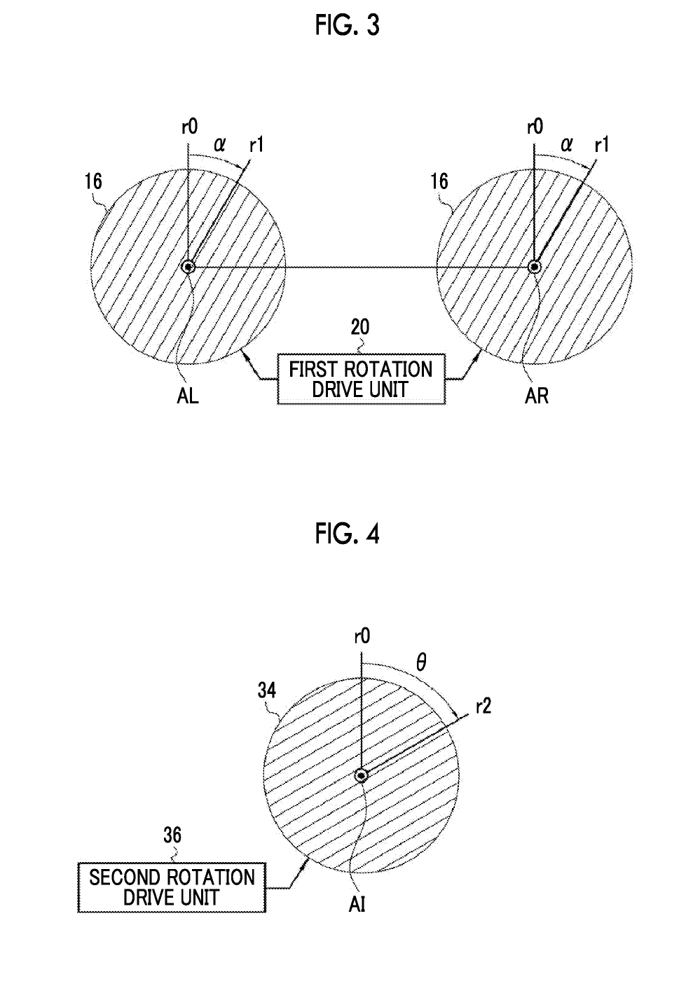

The first polarizing element 16 is a polarization filter that transmits a linear polarized component in a direction along a polarization axis r1 (see FIG. 3) from the optical image. The linear polarized component transmitted through the first polarizing element 16 is incident on the ocular lens 18.

The first polarizing element 16 of the first optical system 10R is configured such that the polarization axis r1 is orthogonal to the optical axis AR and is rotatably disposed using the optical axis AR as the axis of rotation. In addition, the first polarizing element 16 of the second optical system 10L is configured such that the polarization axis r1 is orthogonal to the optical axis AL and is rotatably disposed using the optical axis AL as the axis of rotation. The first polarizing element 16 is rotated and driven by a first rotation drive unit 20.

As shown in FIG. 3, the first rotation drive unit 20 recognizes an angle α between the polarization axis r1 of the first polarizing element 16 and a reference direction r0. The first rotation drive unit 20 changes the angle α by rotating the first polarizing element 16. The reference direction r0 is a direction perpendicular to a plane including the optical axis AR and the optical axis AL.

The first rotation drive unit 20 rotates the first polarizing element 16 of the second optical system 10L together with the first polarizing element 16 of the first optical system 10R. The first rotation drive unit 20 is controlled by a rotation control unit 32.

The ocular lens 18 is disposed on a first optical path. Incidence ray having passed through the objective lens 12, the erecting prism 14, and the first polarizing element 16 is guided to the ocular lens 18. The ocular lens 18 is constituted by a plurality of optical lenses including a zoom lens 18a. The angle of view of the first optical path can be changed by moving the zoom lens 18a on the basis of the operation of the zoom operating unit 11b. The angle of view becomes smaller as zoom magnification increases by the operation of the zoom operating unit 11b.

Similarly to the first optical system 10R, the second optical system 10L includes an objective lens 12, an erecting prism 14, a first polarizing element 16, and an ocular lens 18. The objective lens 12, the erecting prism 14, the first polarizing element 16, and the ocular lens 18 are disposed on the optical axis AL of the second optical system 10L in this order from the observation object side.

In addition, a polarization control unit 22 is provided inside the binoculars 10. The polarization control unit 22 is disposed on the optical axis AI of the imaging optical system 101. The polarization control unit 22 operates in a case where the observation mode is set to the automatic mode by the mode switching button 11 a being operated.

The polarization control unit 22 includes an objective lens 24, a linear polarized component extraction unit 26, the imaging element 28, a polarization direction detection unit 30, and the rotation control unit 32. Light is incident on the objective lens 24 from the observation object. Similarly to the objective lens 12, the objective lens 24 is configured such that the optical images can be focused.

The angle of view of the imaging optical system 101 is coincident with the angle of view in a case where zoom magnification is smallest in the first optical system 10R and the second optical system 10L. That is, in a case where the zoom magnification is smallest, an observation range observed the first ocular portion ER and the second ocular portion EL and an imaging range based on the imaging element 28 are coincident with each other.

In the linear polarized component extraction unit 26, an incidence ray is incident from the objective lens 24, and linear polarized components are respectively extracted from the incidence ray with respect to a plurality of polarization directions. The linear polarized component extraction unit 26 is constituted by a second polarizing element 34 and a second rotation drive unit 36.

The second polarizing element 34 is a polarization filter that transmits a linear polarized component in a direction along a polarization axis r2 (see FIG. 4) from the optical image. Light transmitted through the second polarizing element 34 is incident on the imaging element 28.

The second polarizing element 34 is configured such that the polarization axis r2 is orthogonal to the optical axis AI and is rotatably disposed using the optical axis AI as the axis of rotation. The second polarizing element 34 is rotated and driven by the second rotation drive unit 36.

As shown in FIG. 4, the second rotation drive unit 36 recognizes an angle θ between the polarization axis r2 of the second polarizing element 34 and the reference direction r0. The second rotation drive unit 36 changes the angle θ by rotating the second polarizing element 34. The second rotation drive unit 36 is controlled by the polarization direction detection unit 30. The second rotation drive unit 36 corresponds to a “second drive unit” in the claims.

The imaging element 28 outputs imaging signals by individually capturing images of the respective linear polarized components extracted by the linear polarized component extraction unit 26. An example of the imaging element 28 to be used includes a complementary metal oxide semiconductor (CMOS) type image sensor or a charge coupled device (CCD) type image sensor. Meanwhile, in the present embodiment, a monochrome image sensor which does not have a color filter is used as the imaging element 28.

The polarization direction detection unit 30 causes the imaging element 28 to perform imaging while changing the angle θ of the second polarizing element 34, acquires a plurality of imaging signals, and obtains the luminance of an observation image from each of the imaging signals, to thereby detect an optimum polarization direction which is a polarization direction optimum for observation. In the present embodiment, the polarization direction detection unit 30 specifies a polarization direction in which the luminance of the observation image becomes lowest as the optimum polarization direction.

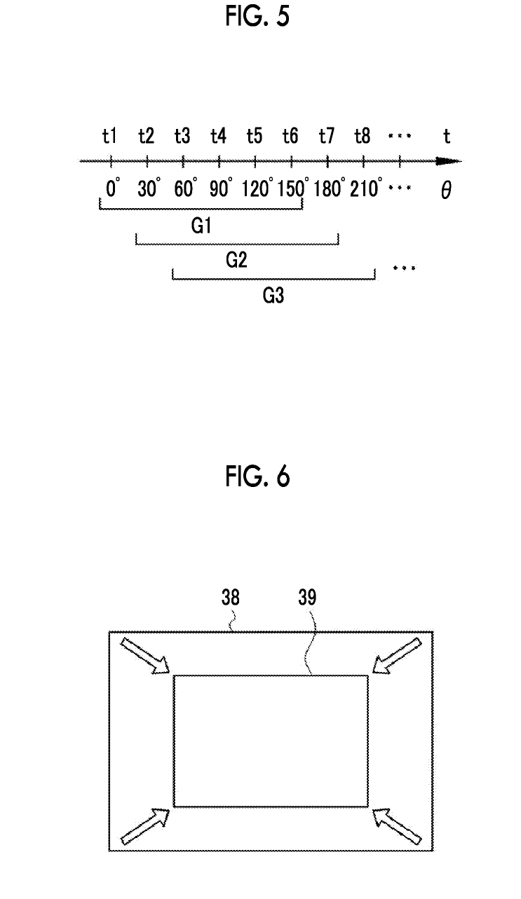

Specifically, the polarization direction detection unit 30 controls the second rotation drive unit 36 and the imaging element 28, synchronizes a change timing of the angle θ of the second polarizing element 34 with an imaging timing t based on the imaging element 28, as shown in FIG. 5, and causes the imaging element 28 to perform an imaging operation every time the angle θ is changed by a predetermined angle.

Since the polarization direction detection unit 30 detects a polarization direction (optimum polarization direction) in which the luminance of the observation image becomes lowest, the amount of change in the angle θ changing between imaging timings is preferably as small as possible, but is set to 30° in the present embodiment. Meanwhile, the polarization direction detection unit 30 stops the second polarizing element 34 for a predetermined period every time the angle θ of the second polarizing element 34 is changed by 30° by the second rotation drive unit 36, and causes the imaging element 28 to perform an imaging operation during this stop.

In addition, in order to detect an optimum polarization direction, it is not necessary to detect the optimum polarization direction on the basis of a plurality of imaging signals obtained in a range in which the angle of the second polarizing element 34 is 360°, and it is sufficient to just detect the optimum polarization direction on the basis of a plurality of imaging signals obtained in a range in which the angle of the second polarizing element 34 is 180°. This is because linear polarized components obtained in a case where the directions of the polarization axis r2 of the second polarizing element 34 are different from each other by 180° are the same as each other.

Therefore, the polarization direction detection unit 30 detects an optimum polarization direction on the basis of a plurality of imaging signals obtained within a range in which the angle of the second polarizing element 34 is 180°. In the present embodiment, since the amount of change in the angle θ changing between the respective imaging timings is set to 30°, the optimum polarization direction is detected on the basis of 6 frames' worth of imaging signals (signal group) obtained by six imaging timings.

Specifically, the polarization direction detection unit 30 first detects an optimum polarization direction on the basis of 6 frames' worth of signal group G1 at imaging timings t1 to t6. In a case where an imaging signal is obtained at an imaging timing t7, the polarization direction detection unit 30 detects an optimum polarization direction on the basis of 6 frames' worth of signal group G2 at imaging timings t2 to t7. Thereafter, similarly, every time a new imaging signal is obtained, an optimum polarization direction is detected on the basis of 6 frames' worth of signal group constituted by this new 1 frame's worth of imaging signal and the previous 5 frames' worth of imaging signals. In this manner, the frequency of detection of an optimum polarization direction increases by forming a signal group and detecting an optimum polarization direction.

In addition, when the luminance of the observation image is obtained from each imaging signal, the polarization direction detection unit 30 obtains the luminance from the imaging signal on the basis of a pixel signal within a region corresponding to the angle of view of the first optical path. Specifically, since the angle of view of the first optical path changes depending on zoom magnification based on the operation of the zoom operating unit 11b, the polarization direction detection unit 30 receives a signal relating to the zoom magnification from the zoom operating unit 11b, and sets a detection region 39 corresponding to the angle of view of the first optical path, within an imaging range 38 based on the imaging element 28, in accordance with the zoom magnification, as shown in FIG. 6. The polarization direction detection unit 30 calculates the luminance by obtaining an average value of pixel signals within the detection region 39.

The polarization direction detection unit 30 obtains the luminance of each imaging signal within a signal group, and sets the angle θ_{P} of the second polarizing element 34 in which an imaging signal having minimum luminance is obtained to an optimum polarization direction. Meanwhile, in a case where the angle θ_{P} obtained as the optimum polarization direction is equal to or greater than 180°, a value subtracted by 180° from this angle θ_{P} is set to the optimum polarization direction. This is because linear polarized components obtained in a case where the directions of the polarization axis r2 of the second polarizing element 34 are different from each other by 180° are the same as each other.

The rotation control unit 32 controls the first rotation drive unit 20, and rotates the first polarizing element 16 at an angle that allows the transmission of a linear polarized component in the optimum polarization direction detected by the polarization direction detection unit 30. Specifically, the rotation control unit 32 rotates the first polarizing element 16 so that the angle a of the first polarizing element 16 is set to the angle θ_{P} obtained as the optimum polarization direction. As described above, in a case where the angle θ_{P} is equal to or greater than 180°, a value subtracted by 180° from this angle θ_{P} is set to the optimum polarization direction, and thus the angle α of the first polarizing element 16 is changed within a range of 0°≦α<180°.

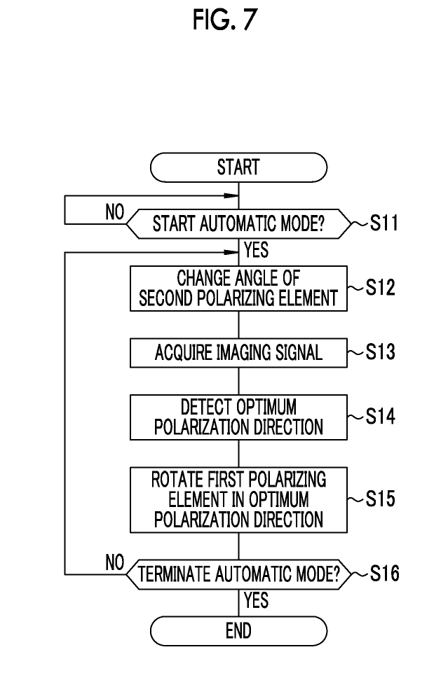

The action of the binoculars 10 configured in this manner will be described with reference to a flow diagram shown in FIG. 7. The binoculars 10 bring the polarization control unit 22 into operation in a case where the mode switching button 11a is operated, and the automatic mode is started (YES in step S11).

The polarization direction detection unit 30 acquires imaging signals by the imaging element 28 (step S13) while changing the angle θ of the second polarizing element 34 by every 30° (step S12). The polarization direction detection unit 30 calculates luminance on the basis of each of the acquired imaging signals, and detects the angle θ_{P} at which the luminance becomes lowest as the optimum polarization direction (step S14). Specifically, every time the angle θ is changed and a new imaging signal is obtained, the polarization direction detection unit 30 detects an optimum polarization direction on the basis of 6 frames' worth of signal group constituted by this new 1 frame's worth of imaging signal and the previous 5 frames' worth of imaging signals.

The rotation control unit 32 controls the first rotation drive unit 20, and rotates the first polarizing element 16 at an angle that allows the transmission of a linear polarized component in the detected optimum polarization direction (step S15). Step S12 to step S15 are repeatedly performed while the observation mode is set to the automatic mode (NO in step S16). In a case where the mode switching button 11a is operated again, the automatic mode is terminated (YES in step S16).

In this manner, in the automatic mode, since the optimum polarization direction is sequentially detected while the second polarizing element 34 is rotated, and the first polarizing element 16 is set in the optimum polarization direction every time the optimum polarization direction is detected, the first polarizing element 16 can be maintained in the optimum polarization direction at all times. Therefore, a case does not occur in which the brightness of the observation image changes with the detection of the optimum polarization direction, as in the related art. When a user observes a scene including the surface of the water, window glass or the like, the user can observe an observation image in which unnecessary light such as reflected light is cut. This automatic mode is suitable for a scene in which an observation object changes, and a great fluctuation occurs in unnecessary light such as reflected light.

In addition, in the fixed mode, the rotation control unit 32 controls the first rotation drive unit 20, and sets the angle α of the first polarizing element 16 to 0°. In this fixed mode, since the polarization control unit 22 does not operate, electric power saving is achieved. This fixed mode is suitable for a scene in which there is a small change in the observation object, and a great fluctuation does not occur in unnecessary light such as reflected light.

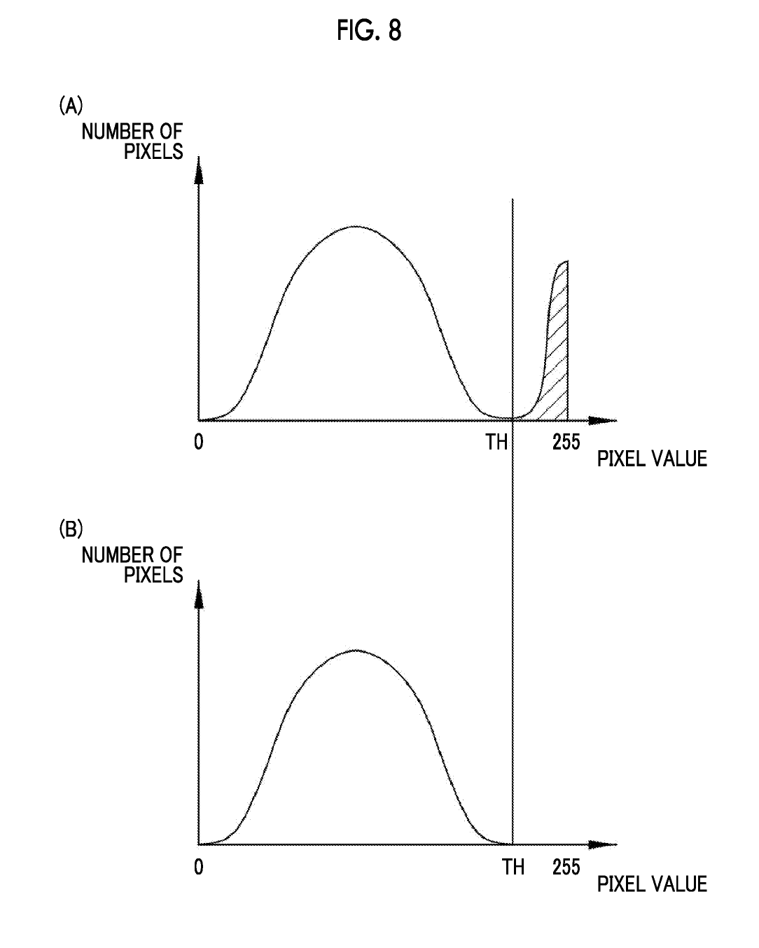

Meanwhile, in the embodiment, the optimum polarization direction is detected on the basis of the luminance of the imaging signal, but the optimum polarization direction may be detected on the basis of the frequency distribution of the pixel value of the imaging signal. FIG. 8 shows the frequency distribution of pixel values based on the imaging signal obtained by capturing an image of an observation object. The pixel values for generating this frequency distribution are acquired from the inside of the aforementioned detection region 39.

In a scene including the surface of the water, window glass or the like, the luminance of unnecessary light such as reflected light tends to be high. For this reason, in a situation where the angle θ of the second polarizing element 34 is not in an optimum polarization direction, and the unnecessary light is not sufficiently cut, the frequency distribution shows a great frequency in a region (high-luminance region) having a large pixel value, as shown in (A) of FIG. 8. Therefore, the optimum polarization direction can be detected by obtaining an angle θ_{P} at which a cumulative frequency in a high-luminance region is minimized.

Specifically, a threshold value TH is set, a cumulative frequency equal to or greater than the threshold value TH is obtained from an imaging signal obtained every time the angle θ of the second polarizing element 34 is changed, an angle θ_{P} at which this cumulative frequency is minimized is obtained, and this direction is set to an optimum polarization direction. In this optimum polarization direction, since the entirety of unnecessary light such as reflected light is substantially cut by the second polarizing element 34, the cumulative frequency equal to or greater than the threshold value TH is set to substantially zero, as shown in (B) of FIG. 8.

In this manner, the optimum polarization direction can be detected on the basis of the cumulative frequency equal to or greater than the threshold value TH. The threshold value TH may be appropriately changed.

Meanwhile, in the embodiment, the rotation of the second polarizing element 34 is stopped every time the angle θ of the second polarizing element 34 is changed by a predetermined angle, and the imaging element 28 is caused to perform imaging during this stop, but the imaging element 28 may be caused to perform imaging at a timing when the angle θ takes a predetermined angle in a state where the second polarizing element 34 is rotated at a constant speed.

### Second Embodiment

In the first embodiment, a plurality of linear polarized components are sequentially extracted from an optical image by rotating the second polarizing element 34, but in a second embodiment, the plurality of linear polarized components are simultaneously extracted.

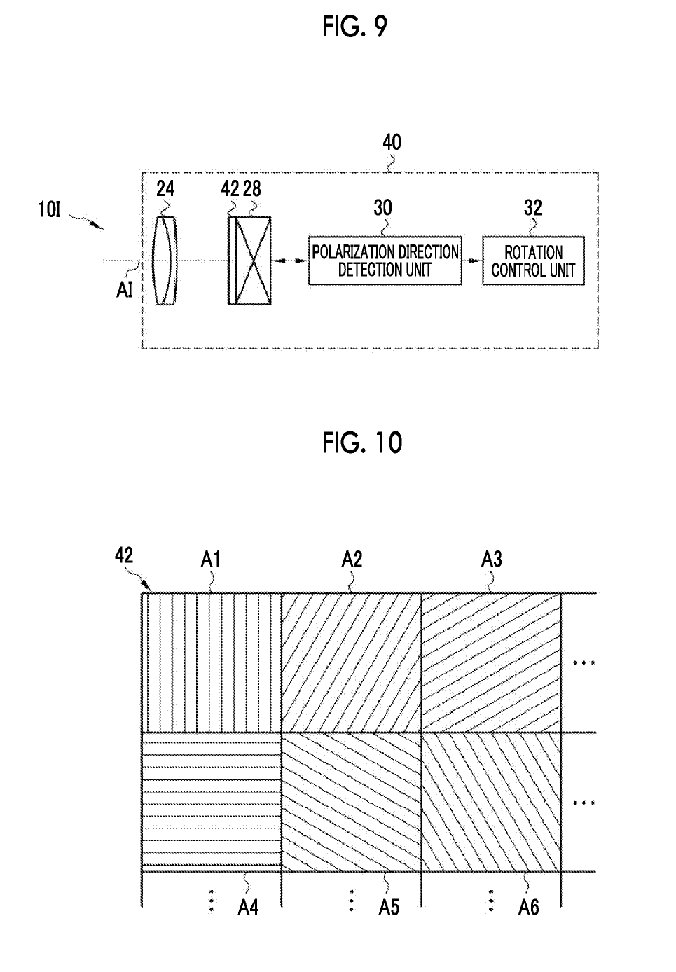

As shown in FIG. 9, a polarization control unit 40 of the second embodiment is configured such that a third polarizing element 42 is fixedly disposed between the objective lens 24 and the imaging element 28, instead of the second polarizing element 34 and the second rotation drive unit 36 of the polarization control unit 22. The third polarizing element 42 corresponds to a “linear polarized component extraction unit” in the claims.

As shown in FIG. 10, the third polarizing element 42 has first to sixth polarization regions A1 to A6 of which the polarization axes are different in direction from each other. The first to sixth polarization regions A1 to A6 have repetitive patterns arrayed in longitudinal and transverse directions. The angles of the polarization axes of the first to sixth polarization regions A1 to A6 with respect to the reference direction r0 are set to 0°, 30°, 60°, 90°, 120°, and 150° in order.

Therefore, the same linear polarized components in 6 directions as those in the first embodiment are simultaneously extracted by causing the optical image to be incident on the first to sixth polarization regions A1 to A6. Meanwhile, the first to sixth polarization regions A1 to A6 have repetitive patterns arrayed in longitudinal and transverse directions. Therefore, even in a case where the size of the detection region 39 changes due to a change in the angle of view associated with a zoom operation, at least a set of first to sixth polarization regions A1 to A6 are included within the detection region 39.

In the second embodiment, the luminance of each linear polarized component is obtained on the basis of the pixel value of the detection region 39, and an optimum polarization direction in which this luminance is minimized is detected. Other configurations of the second embodiment are the same as those of the first embodiment.

In the second embodiment, since the linear polarized components are simultaneously extracted with respect to a plurality of polarization directions, a detection time in an optimum polarization direction is further shortened than in a case where the linear polarized components are sequentially extracted as in the first embodiment. In addition, in the second embodiment, since it is not necessary to provide the second rotation drive unit 36 for rotating the second polarizing element 34 as in the first embodiment, space saving and electric power saving is achieved.

Meanwhile, the third polarizing element 42 may be directly formed on the imaging surface of the imaging element 28 by a semiconductor manufacturing process or the like. In addition, in the second embodiment, it is also possible to detect an optimum polarization direction on the basis of the frequency distribution of the pixel values of the imaging signal.

### Third Embodiment

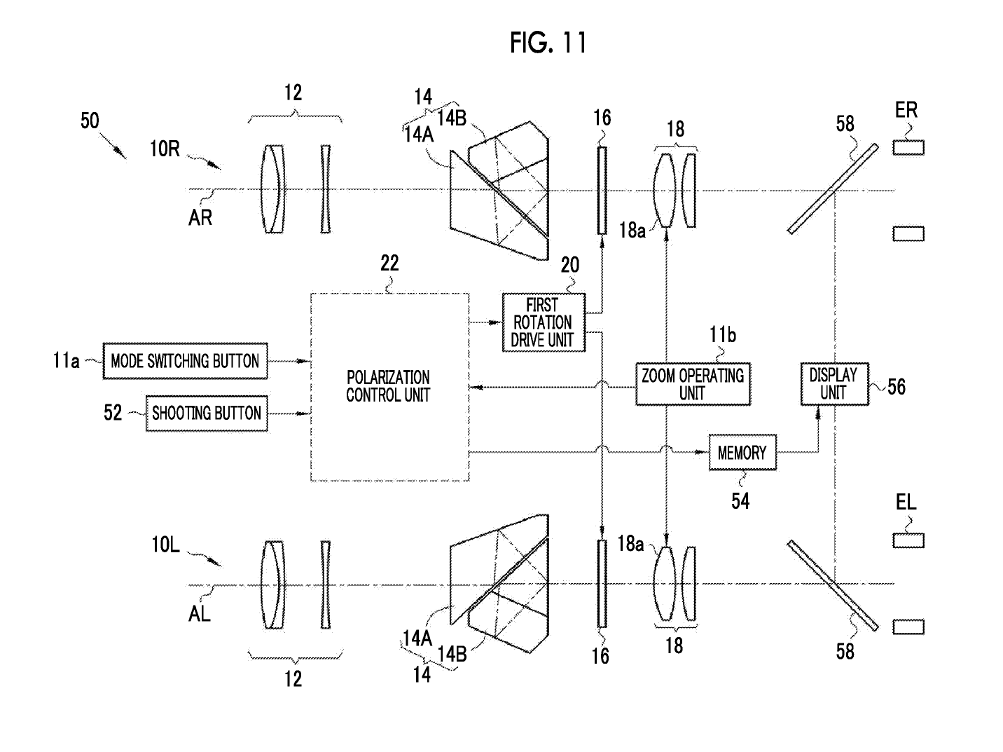

In a third embodiment, it is possible to perform recording of an image obtained by the imaging element 28, and to guide this image to the first ocular portion ER and the second ocular portion EL. As shown in FIG. 11, binoculars 50 of the third embodiment include a shooting button 52, a memory 54, a display unit 56, and a half mirror 58, in addition to the configuration of the binoculars 10 of the first embodiment.

In addition, in the first embodiment, a monochrome image sensor is used as the imaging element 28, but in the third embodiment, a color image sensor having multi-color pixels is used as the imaging element in order to display a color image on the display unit 56.

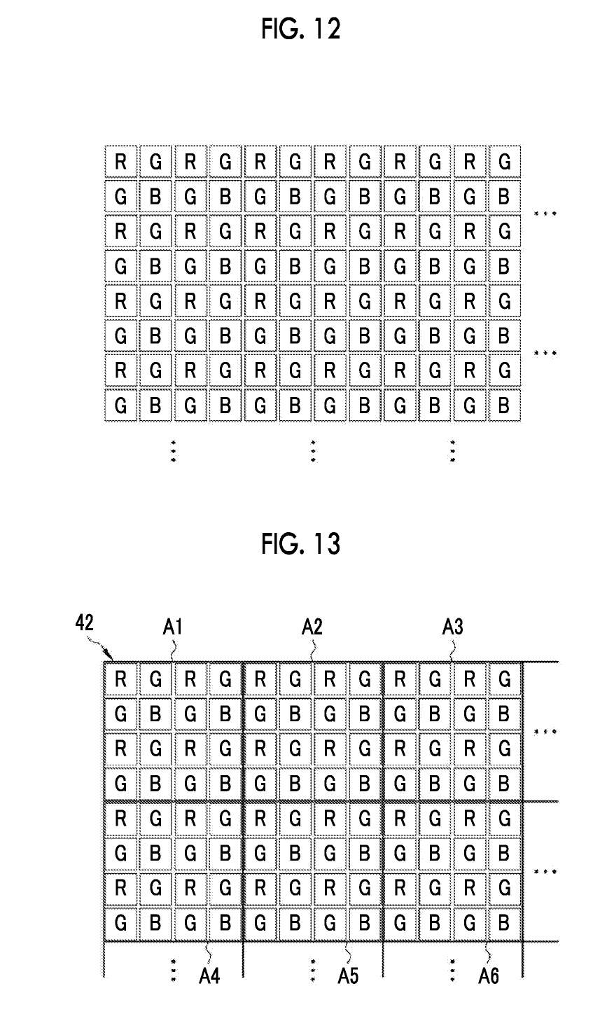

As shown in FIG. 12, each pixel of the imaging element 28 is provided with any of a B(blue) filter, a G(green) filter, and a R(red) filter. In the present embodiment, the color array of a color filter is set to a Bayer array. The B pixel provided with a B filter outputs a B imaging signal. The G pixel provided with a G filter outputs a G imaging signal. The R pixel provided with a R filter outputs a R imaging signal.

In the present embodiment, the polarization direction detection unit 30 generates a luminance signal by performing Y/C conversion on the imaging signal of BGR which is output from the imaging element 28. The polarization direction detection unit 30 detects an optimum polarization direction on the basis of the luminance of the observation image obtained from the luminance signal.

The shooting button 52 is operated when the still image of the observation object is captured. The operation of the shooting button 52 is effective at the time of the automatic mode. An image based on the imaging signal in which the optimum polarization direction is detected by the polarization direction detection unit 30, when the shooting button 52 is operated, is stored as an optimum image in the memory 54. In addition, the display unit 56 displays the optimum image.

The half mirror 58 is disposed on the optical axis AR between the ocular lens 18 and the first ocular portion ER in the first optical system 10R, and is disposed on the optical axis AL between the ocular lens 18 and the second ocular portion EL in the second optical system 10L. The image displayed on the display unit 56 is guided to the first ocular portion ER and the second ocular portion EL through the half mirror 58. The image displayed on display unit 56 is superimposed on the optical image.

In this manner, in the third embodiment, in a case where a still image is captured, an optimum still image in which unnecessary light such as reflected light is cut is automatically acquired. In addition, this optimum still image can be confirmed through the first ocular portion ER and the second ocular portion EL.

Meanwhile, in the third embodiment, similarly to the second embodiment, the third polarizing element 42 is used instead of the second polarizing element 34, and thus it is possible to simultaneously extract a plurality of linear polarized components from the optical image. In this case, as shown in FIG. 13, in order to generate a luminance signal from each of the first to sixth polarization regions A1 to A6, at least or more of each of the B pixel, the G pixel, and the R pixel are disposed in each of the first to sixth polarization regions A1 to A6.

In addition, in the third embodiment, a primary color sensor of BGR is used as the imaging element 28, but a complementary color sensor may be used instead thereof.

In addition, in the third embodiment, a configuration is used in which the image displayed on the display unit 56 is superimposed on the optical image, but a configuration may be used in which the first optical system 10R and the second optical system 10L are provided with a shutter mechanism to thereby light-shield the first optical system 10R and the second optical system 10L while an image is displayed on the display unit 56, and only a display image of the display unit 56 is guided to the first ocular portion ER and the second ocular portion EL. In addition, the half mirror 58 may be provided on any one of the optical axis AR and the optical axis AL, without being provided on both the optical axes.

In addition, in the third embodiment, a configuration is used in which the display image of the display unit 56 is guided to the first ocular portion ER and the second ocular portion EL, but a configuration may be used in which the display unit 56 may be provided in the housing (not shown) of the binoculars 50, and the display image of the display unit 56 may be displayed directly to a user without being guided to the first ocular portion ER and the second ocular portion EL. The display unit 56 in this case corresponds to an “observation unit” in the claims.

### Fourth Embodiment

In a first embodiment, the visibility of the observation image is increased by cutting unnecessary light such as reflected light in the first polarizing element 16 when a scene including the surface of the water, window glass or the like is observed. However, not only unnecessary light such as reflected light, but also direct light from a high-luminance subject such as the sun, and the like are included in a scene to be observed, and such light lowers the visibility of the observation image without being sufficiently cut in the first polarizing element 16.

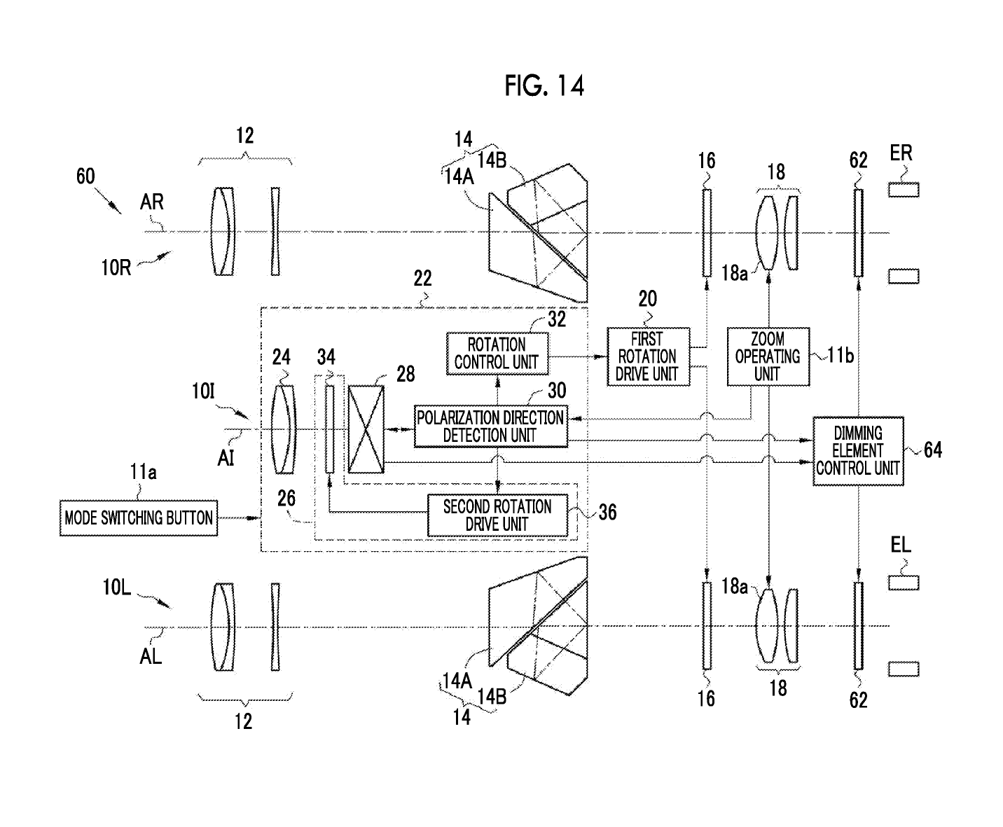

Therefore, as shown in FIG. 14, binoculars 60 of the fourth embodiment are provided with a dimming element 62 and a dimming element control unit 64, in addition to the configuration of the binoculars 10 of the first embodiment.

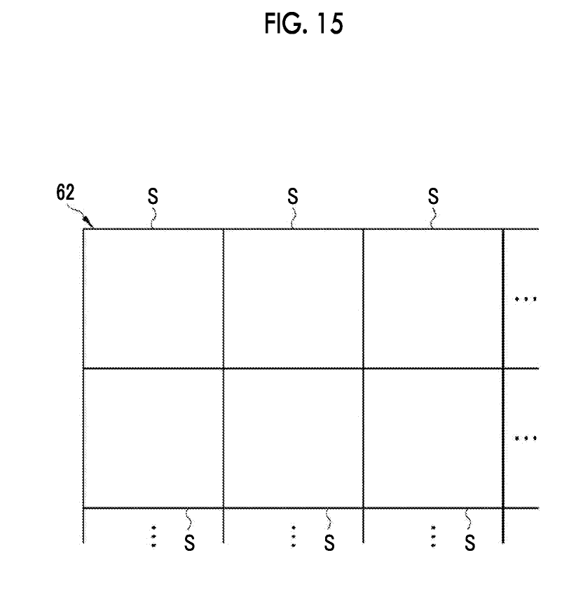

As shown in FIG. 15, the dimming element 62 has a plurality of segments S of which the light transmittance is variable. The dimming element 62 is disposed between the ocular lens 18 and the first ocular portion ER of the first optical system 10R, and the ocular lens 18 and the second ocular portion EL of the second optical system 10L.

The dimming element 62 is constituted by, for example, a polymer network liquid crystal (PNLC) filter. The segments S of the dimming element 62 are arrayed in a two-dimensional matrix. The dimming element 62 adjusts (dims) the amount of light of the optical image from the ocular lens 18 for each of the segments S.

The dimming element control unit 64 individually controls the light transmittances of the respective segments S of the dimming element 62, on the basis of the imaging signal in which the optimum polarization direction is detected by the polarization direction detection unit 30. The dimming element control unit 64 ascertains a correspondence relation between the pixel of the imaging element 28 and the segment S.

The dimming element control unit 64 acquires the imaging signal in which the optimum polarization direction is detected by the polarization direction detection unit 30, from the imaging element 28. The dimming element control unit 64 obtains the luminance of a pixel corresponding to the segment S of the dimming element 62, on the basis of the acquired imaging signal. The dimming element control unit 64 obtains luminance for each segment S by obtaining the average value of luminance with respect to the pixel corresponding to the segment S. The dimming element control unit 64 specifies a segment S including a high-luminance region of which the luminance is equal to or greater than a specific threshold value, among the respective segments S. The dimming element control unit 64 lowers the light transmittance of the specified segment S, to thereby reduce the amount of light transmitted through this segment S.

In this manner, in the present embodiment, the light transmittance of a segment S corresponding to a high-luminance subject such as the sun is lowered, and thus the visibility of the observation image further improves.

Meanwhile, the dimming element 62 is disposed between the ocular lens 18 and the first ocular portion ER, and the ocular lens 18 and the second ocular portion EL, but the dimming element 62 may be disposed on the optical axis AR and the optical axis AL, and the disposition position is particularly limited. However, it is preferable that the dimming element 62 is disposed at a position close to the first ocular portion ER and the second ocular portion EL.

### Fifth Embodiment

In the first embodiment, the second optical path for incorporating the optical image into the polarization control unit 22 is provided independently from the first optical path of the first optical system 10R and the second optical system 10L, but the second optical path may be formed by branching the first optical path through an optical member.

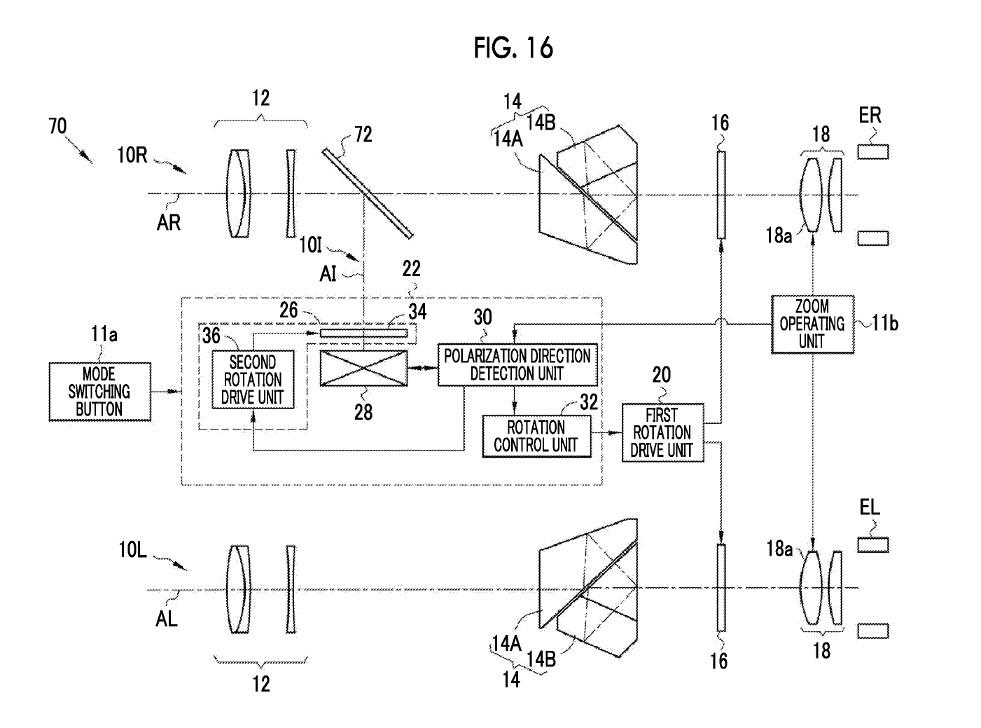

In the binoculars 70 of the fifth embodiment, as shown in FIG. 16, an optical member 72 is provided between the objective lens 12 and the erecting prism 14 of the first optical system 10R in addition to the configuration of the binoculars 10 of the first embodiment, and thus the optical axis AI is branched from the optical axis AR.

The optical member 72 is, for example, a transparent plate, reflects a portion of an incidence ray from the objective lens 12 using Fresnel reflection to guide the reflected light to the polarization control unit 22, and transmits other light to guide the transmitted light to the erecting prism 14.

In the present embodiment, since the optical axis AI is branched from the optical axis AR by the optical member 72, the objective lens 12 is shared by the first optical system 10R and the imaging optical system 101. Therefore, the angle of view of the first optical path and the angle of view of the second optical path are the same as each other at all times. Therefore, in the present embodiment, as in the first embodiment, the detection region 39 for detecting luminance is not required to be changed in accordance with the angle of view of the first optical path, and the luminance may be calculated using all the signals within the imaging range 38 at all times, regardless of zoom magnification.

In addition, the optical member 72 may be disposed so that the angle of incidence of light propagating through the first optical path (optical axis AR) on the optical member 72 is set to a Brewster's angle. In this case, light reflected by the optical member 72 and guided to the second optical path (optical axis AI) is changed to a substantially S-polarized component. Since this S-polarized component is a main component included in the unnecessary light, a change in luminance associated with the rotation of the second polarizing element 34 clarifies, and the accuracy of detection of an optimum polarization direction improves.

Meanwhile, in the present embodiment, it goes without saying that the third polarizing element 42 can be used instead of the second polarizing element 34. In addition, the optical member 72 may be other optical members such as a half mirror.

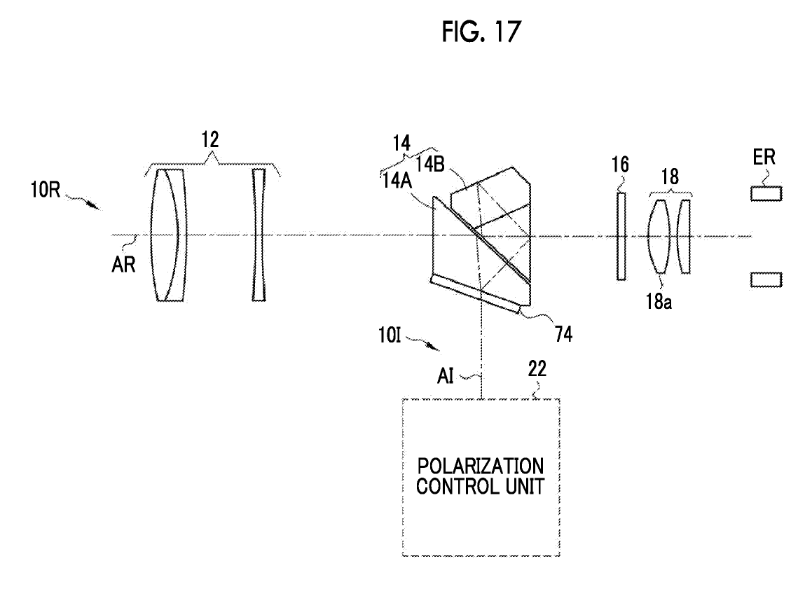

In addition, as shown in FIG. 17, the second optical path (optical axis AI) for incorporating the optical image into the polarization control unit 22 may be formed by providing a half mirror 74 on the non-total reflection surface of the erecting prism 14 instead of the optical member 72, and emitting a portion of the optical image from the erecting prism 14. Thereby, space saving is further achieved.

### Sixth Embodiment

In the embodiment, the angle α of the first polarizing element 16 is set on the basis of the optimum polarization direction (angle θ_{P}) detected by the polarization direction detection unit 30. However, depending on the use condition of the binoculars 10, there is the possibility of a shift occurring in an optimum polarization direction and the set position of the first polarizing element 16 which is set in reality on the basis of this optimum polarization direction. Consequently, binoculars 80 of the sixth embodiment can execute a calibration operation for calibrating the set position of the first polarizing element 16 by the rotation control unit 32.

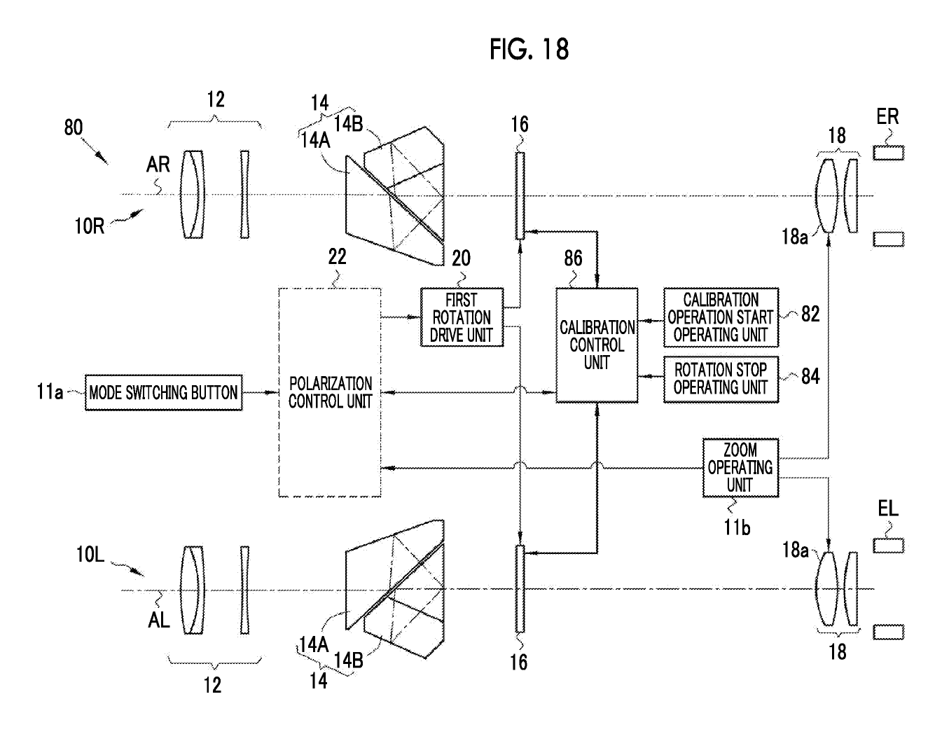

In FIG. 18, the binoculars 80 of the sixth embodiment includes a calibration operation start operating unit 82, a rotation stop operating unit 84, and a calibration control unit 86, in addition to the configuration of the binoculars 10 of the first embodiment.

The calibration operation start operating unit 82 is operated when the calibration operation is started. The rotation stop operating unit 84 is operated when a user stops the rotation of the first polarizing element 16 rotated during the execution of the calibration operation.

In a case where the calibration operation start operating unit 82 is operated, the calibration control unit 86 rotates the first polarizing element 16 by driving the first rotation drive unit 20. In a case where the first polarizing element 16 is rotated, the brightness of the observation image periodically changes with the rotation of the first polarizing element 16. A user is caused to operate the rotation stop operating unit 84 at a timing when the brightness becomes lowest.

In a case where the rotation stop operating unit 84 is operated, the calibration control unit 86 stops the rotation of the first polarizing element 16, and detects the rotation stop position of the stopped first polarizing element 16. The rotation stop operating unit 84 specifies the angle α of the first polarizing element 16 on the basis of the detected rotation stop position.

The calibration control unit 86 compares the specified angle α with the angle θ_{P} corresponding to the optimum polarization direction detected by the polarization direction detection unit 30, and obtains an angle difference. The calibration control unit 86 controls the rotation control unit 32, and calibrates the set position of the first polarizing element 16 based on the optimum polarization direction, on the basis of the obtained angle difference.

Meanwhile, in the sixth embodiment, the set position of the first polarizing element 16 is calibrated on the basis of the rotation stop position of the first polarizing element 16 stopped at a timing when the brightness of the observation image becomes lowest, but the set position of the first polarizing element 16 may be calibrated on the basis of the rotation stop position of the first polarizing element 16 stopped at a timing when the brightness of the observation image becomes highest.

In addition, the calibration control unit 86 may calibrate the set position of the first polarizing element 16 on the basis of both the rotation stop position of the first polarizing element 16 stopped at a timing when the brightness of the observation image becomes lowest and the rotation stop position of the first polarizing element 16 stopped at a timing when the brightness of the observation image becomes highest.

In addition, in the sixth embodiment, the operation of the rotation stop operating unit 84 is performed on the basis of the observation image to be observed through the first ocular portion ER and the second ocular portion EL, but the rotation stop operating unit 84 may be operated while an image displayed on the display unit 56 of the third embodiment is observed. In this case, for example, a configuration is used in which the optical image is prevented from being guided to the second optical system 10L by a shutter mechanism or the like, and the image from the display unit 56 is guided to the second ocular portion EL. Therefore, the optical image is guided to the first ocular portion ER, and an image (optimum image) generated on the basis of the imaging signal in which the optimum polarization direction is detected is guided to the second ocular portion EL. Thereby, a user can perform the operation of the rotation stop operating unit 84 while observing the optimum image through the user's left eye, and observing a real optical image through the user's right eye.

In the respective embodiments, the present invention has been described by taking an example of binoculars, but the present invention can also be applied to other optical observation devices such as a monocle or a telescope.

### EXPLANATION OF REFERENCES

10, 50, 60, 70, 80 binoculars

10R: first optical system

10L: second optical system

10I: imaging optical system

11: operating unit

11a: mode switching button

11b: zoom operating unit

12: objective lens

14: erecting prism

14A: auxiliary prism

14B: roof prism

16: first polarizing element

18: ocular lens

18a: zoom lens

20: first rotation drive unit

22, 40: polarization control unit

24: objective lens

26: linear polarized component extraction unit

28: imaging element

30: polarization direction detection unit

32: rotation control unit

34: second polarizing element

36: second rotation drive unit

38: imaging range

39: detection region

42: third polarizing element

52: shooting button

54: memory

56: display unit

58, 74: half mirror

62: dimming element

64: dimming element control unit

72: optical member

82: calibration operation start operating unit

84: rotation stop operating unit

86: calibration control unit

AR: optical axis

AL: optical axis

AI: optical axis

ER: first ocular portion

EL: second ocular portion

r1: polarization axis

r2: polarization axis

What is claimed is:

1. An optical observation device comprising:
an objective lens on which light is incident from an observation object;
an observation unit to which an incidence ray incident on the objective lens is guided through a first optical path;
a first polarizing element which is a polarizing element that transmits a specific linear polarized component, and is rotatably disposed on a surface orthogonal to an optical axis of the first optical path;
a first rotation drive unit that rotates and drives the first polarizing element;
a linear polarized component extraction unit, disposed on a second optical path having the same angle of view as that of the first optical path or having a larger angle of view than that of the first optical path, which extracts linear polarized components from the incidence ray, respectively, with respect to a plurality of polarization directions;
an imaging element that individually captures images of the respective linear polarized components extracted by the linear polarized component extraction unit and outputs imaging signals;
a polarization direction detection unit that detects an optimum polarization direction based on an image of the observation object, on the basis of the imaging signals;
a rotation control unit that controls the first rotation drive unit, to set the first polarizing element at an angle that allows transmission of a linear polarized component in the optimum polarization direction;
a rotation stop operating unit that makes it possible for a user to stop a rotation of the first polarizing element which is rotated during execution of a calibration operation for calibrating a set position of the first polarizing element by the rotation control unit; and
a calibration control unit that drives the first rotation drive unit to rotate the first polarizing element, and calibrates the set position on the basis of a difference between a rotation stop position of the first polarizing element stopped by the rotation stop operating unit being operated at a position where an amount of light of an optical image of the observation object guided to the observation unit becomes smallest and the optimum polarization direction detected by the polarization direction detection unit.

2. The optical observation device according to claim 1, wherein the polarization direction detection unit detects a polarization direction in which luminance of the image of the observation object becomes lowest.

3. The optical observation device according to claim 1, wherein the linear polarized component extraction unit includes
a second polarizing element which is a polarizing element that transmits the specific linear polarized component, and is disposed on a surface orthogonal to an optical axis of the second optical path, and
a second rotation drive unit that rotates and drives the second polarizing element, and
sequentially extracts linear polarized components, respectively, with respect to the plurality of polarization directions by causing the imaging element to perform multiple times of imaging operations within a constant angular range in which the second polarizing element is rotated.

4. The optical observation device according to claim 3, wherein the angular range is 180°.

5. The optical observation device according to claim 1, wherein the linear polarized component extraction unit is a third polarizing element, having a plurality of polarization regions divided and fixedly disposed on the second optical path, which simultaneously extracts linear polarized components with respect to the plurality of polarization directions, polarization directions of linear polarized components transmitted by the respective polarization regions being different from each other.

6. The optical observation device according to claim 5, wherein the third polarizing element is provided on an imaging surface of the imaging element.

7. The optical observation device according to claim 6, wherein the imaging element is a color sensor having multi-color pixels, and is configured such that at least one or more pixels of each color are disposed in one polarization region.

8. The optical observation device according to claim 1, further comprising:
a dimming element, having a plurality of segments of which light transmittance is variable, which is disposed on the first optical path; and
a dimming element control unit that controls light transmittances of the respective segments on the basis of the imaging signals in which the optimum polarization direction is detected.

9. The optical observation device according to claim 8, further comprising an ocular lens provided on the first optical path between the first polarizing element and the observation unit, and
wherein the dimming element is disposed between the ocular lens and the observation unit.

10. The optical observation device according to claim 1, wherein a half mirror is disposed on the first optical path, and
the second optical path is branched from the first optical path by the half mirror.

11. The optical observation device according to claim 1, further comprising a display unit that displays an image based on the imaging signals in which the optimum polarization direction is detected.

12. The optical observation device according to claim 11, wherein the image displayed on the display unit is guided to the observation unit through the first optical path.

13. The optical observation device according to claim 1, further comprising a calibration operation start operating unit for starting the calibration operation,
wherein the calibration control unit rotates the first polarizing element while the calibration operation start operating unit is operated, and the rotation stop operating unit is operated.

14. A method of controlling an optical observation device,
the device including
an objective lens on which light is incident from an observation object,
an observation unit to which an incidence ray incident on the objective lens is guided through a first optical path,
a first polarizing element which is a polarizing element that transmits a specific linear polarized component, and is rotatably disposed on a surface orthogonal to an optical axis of the first optical path,
a first rotation drive unit that rotates and drives the first polarizing element,
a linear polarized component extraction unit, disposed on a second optical path having the same angle of view as that of the first optical path or having a larger angle of view than that of the first optical path, which extracts linear polarized components from the incidence ray, respectively, with respect to a plurality of polarization directions,
an imaging element that individually captures images of the respective linear polarized components extracted by the linear polarized component extraction unit and outputs imaging signals,
a polarization direction detection unit that detects an optimum polarization direction based on an image of the observation object, on the basis of the imaging signals,
a rotation control unit that controls the first rotation drive unit, to set the first polarizing element at an angle that allows transmission of a linear polarized component in the optimum polarization direction, and
a rotation stop operating unit that makes it possible for a user to stop a rotation of the first polarizing element which is rotated during execution of a calibration operation for calibrating a set position of the first polarizing element by the rotation control unit,
the method comprising driving the first rotation drive unit to rotate the first polarizing element, and calibrating the set position on the basis of a difference between a rotation stop position of the first polarizing element stopped by the rotation stop operating unit being operated at a position where an amount of light of an optical image of the observation object guided to the observation unit becomes smallest and the optimum polarization direction detected by the polarization direction detection unit.
